(19) United States
(12) Patent Application Publication
(10) Pub. No.: US 2008/0178477 A1
(43) Pub. Date: Jul. 31, 2008

(54) Cutting Instrument

(75) Inventor: Larry Buchtmann, Goldsboro, NC (US)

Correspondence Address: WHYTE HIRSCHBOECK DUDEK S.C., 33 East Main Street, Suite 300, Madison, WI, 53703-4655, US

(73) Assignee: ACME UNITED CORPORATION, Fairfield, CT (US)

(21) Appl. No.: 11/960,626

(22) Filed: Dec. 19, 2007

Related U.S. Application Data
(60) Provisional application No. 60/870,787, filed on Dec. 19, 2006.

(51) Int. Cl. B26B 9/00; B05D 7/24

(52) U.S. Cl. 30/350; 427/299; 427/255.391

(57) ABSTRACT

A new and improved cutting instrument is provided having an enhanced coating. The coating includes titanium, chromium, nitrogen and carbon elements and provides increased wear resistance. The coating can be applied to a variety of metal and non-metallic substrates, which include scissors and knife blades.

### CROSS REFERENCE TO RELATED APPLICATIONS

This application claims priority to U.S. Provisional Patent Application No. 60/870,787, filed on Dec. 19, 2006 and U.S. patent application Ser. No. 11/231,259, filed on Sep. 20, 2005, and is related to U.S. patent application Ser. No. 11/231,151, titled “Coating for Cutting Implements”, filed on Sep. 20, 2005 and herein incorporated by reference in its entirety, which is a continuation-in-part of U.S. Pat. No. 6,988,318, issued Jan. 24, 2006. U.S. and incorporated by reference in its entirety.

### FIELD OF THE INVENTION

Various embodiments of the present invention are directed to cutting instruments. More particularly, various embodiments of the present invention are directed to coatings for cutting instruments.

### BACKGROUND OF THE INVENTION

A cutting instrument is typically formed of a suitable substrate material, such as stainless steel, and a cutting edge is often formed with a wedge-shaped configuration. The edge sharpness varies greatly depending upon the intended use of the instrument. Cutting instruments include, by example, scissors, knife blades, and paper trimmers, each of which can have varied uses. Furthermore, each of these types of instruments can have a significant number of sub-classes, for which the blades can vary widely depending upon the intended use, the price point, and intended consumer. Extended use of the instrument often results in a dulling and wearing effect. Hard coatings are often used to increase wear resistance and hardness of the cutting instrument. It would be advantageous for a cutting instrument to have an improved hard, tough, wear-resistant coating.

### BRIEF DESCRIPTION OF THE DRAWINGS

FIG. 1 is an illustrative example of a cutting instrument in accordance with at least one embodiment of the present invention.

FIG. 2 is a second, opposite view of the cutting instrument in FIG. 1 in accordance with at least one embodiment of the present invention.

FIGS. 3 and 4 are side views of the blades of FIG. 1 in accordance with at least one embodiment of the present invention.

FIG. 5 is a cross sectional view of the cutting instrument in FIG. 1.

FIGS. 6A-6E each contain a table (1-5), which provides coating composition data and corresponding hardness values for the coatings in accordance with multiple embodiments of the present invention.

FIG. 7 is a cross sectional view of an alternative embodiment of the present invention, the coating having two layers.

FIG. 8 is a cross sectional view of an alternative embodiment of the present invention, the coating having three layers.

### DETAILED DESCRIPTION OF THE PREFERRED EMBODIMENT

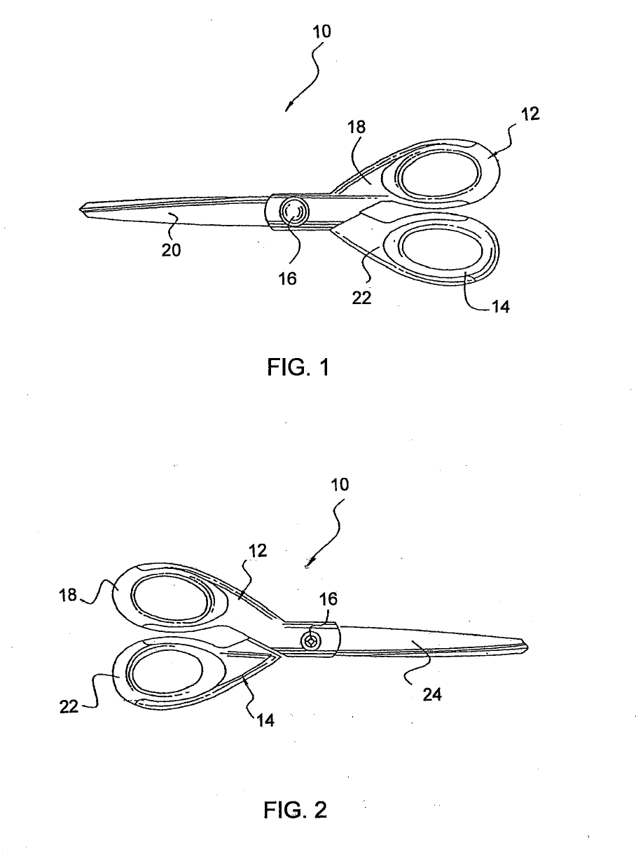

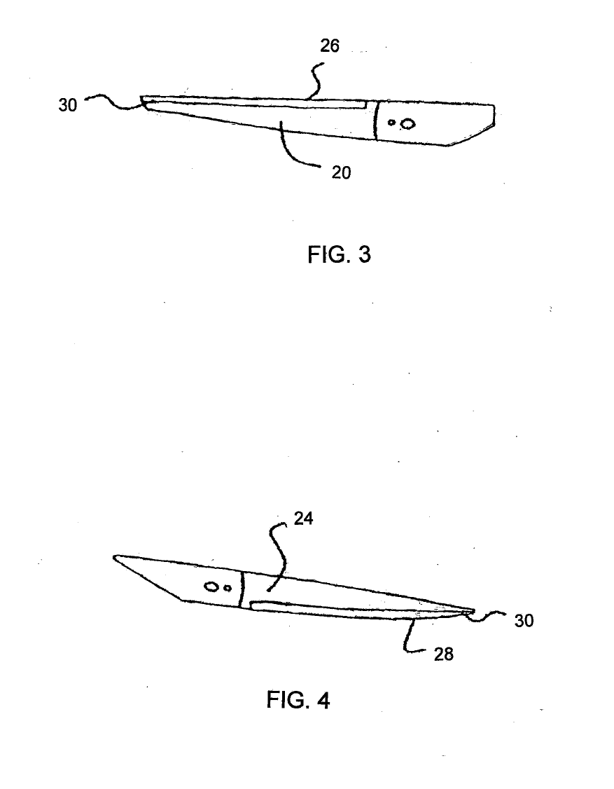

Referring to FIGS. 1-2 an illustrative example of a cutting instrument 10 in the form of a scissors is shown. The scissors 10 has a first portion 12 pivotally connected to a second portion 14 at pivot point 16. The pivot point 16 can be a screw and post, rivet, or some other suitable connecting device. The first portion 12 has a handle 18 and blade 20. The second portion has a handle 22 and blade 24.

The handles 18, 22 are overmolded onto blades 20, 24, respectively. The halves 12, 14 of the scissors 10 have separate handles 18, 22 overmolded onto blades 10, 24, respectively. The handles 18, 22 can alternatively be integrally formed with the blades 20, 24 such that they are formed of the same material having a unitary handle and blade portion (not shown).

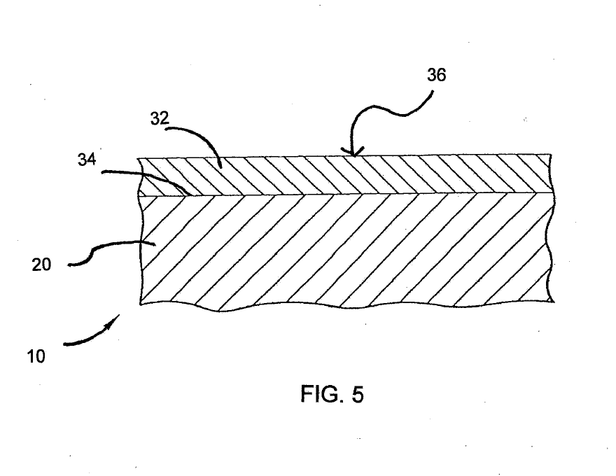

Referring to FIGS. 3-4 blades 20, 24 have a cutting edge 26, 28 respectively. The cutting edge can be in-part formed from a bevel 30 disposed on one side of each blade 20, 24. The bevel 30 can be straight or arcuately shaped. Alternatively, the bevel (not shown) can comprise two or more surfaces that are straight or arcuately shaped. Depending upon the use of the cutting instrument 10, the bevel 30 can be alternately shaped. Cutting instrument 10 provides a pair of complementary cutting blades 20, 24 for cutting a variety of materials.

The blades 20, 24 are manufactured from steel. Alternatively, the blades 20, 24 are manufactured from stainless steel, such as 420 stainless steel. In an alternative embodiment, the blades 20, 24 can be heat-treated to further increase the hardness of the underlying blade substrate. The blade substrate is the underlying blade material that does not include the coating. In an alternative embodiment, the blade substrate can be selected from Damascus steel, carbon steel, surgical stainless steel, galvanized steel, thermo mechanically treated (TMT) steel and steel alloys.

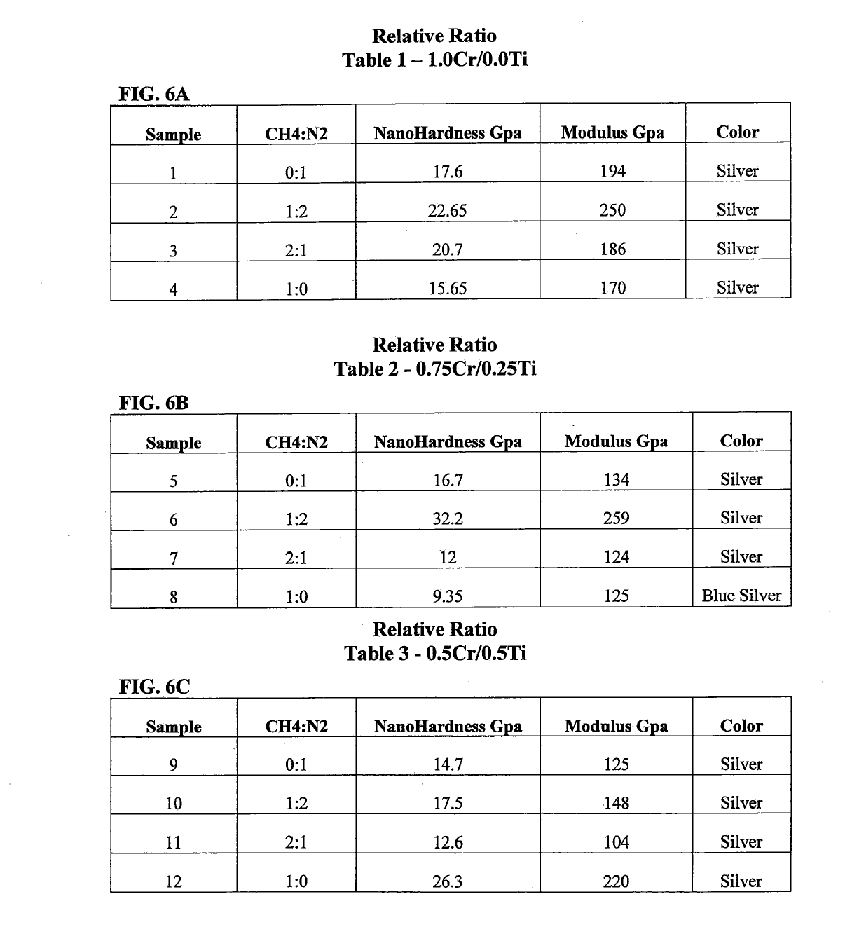

Referring to FIG. 5 a cross section of blade 20 portion is shown. A coating 32 is deposed on surface 34 of blade 20. The coating 32 is deposed on the blade substrate with a pre-defined target coating 32 thickness. The coating 32 thickness has a target range of about 0.05 microns to about 1.0 microns. In an alternative embodiment, the coating 32 has a thickness range from about 0.1 to about 0.6 microns. In yet another alternative embodiment, the coating 32 has a target range of about 0.3 microns to about 0.5 microns. The coating surface 36 is substantially parallel to the substrate surface 34. It is contemplated that the target thickness range can vary from about +/−0.02 microns to about +/−0.15 microns, depending upon the target thickness, and still be within an acceptable range of deviation. By example, with a target thickness of 0.5 microns the standard deviation can be +/−0.1 microns. The coating 32 covers the entire blade 20, 24 surface, as the cutting edge is formed prior to the coating process. In an alternative embodiment, the bevel 30 is not covered by the coating 32 as the bevel 30 is formed after the coating process has occurred. The cutting edge remains coated when the bevel 30 is created after the blades have undergone a coating process. The bevel can be created by a metal cutting or etching process.

Coating 32 provides the blades 20, 24 and cutting edges 26, 28 with tough, hard, wear resistant characteristics. Based in-part upon these characteristics the instrument 10 has substantially increased longevity, while providing the instrument 10 with corrosion resistance, as well as providing a smooth and uniform appearance and color.

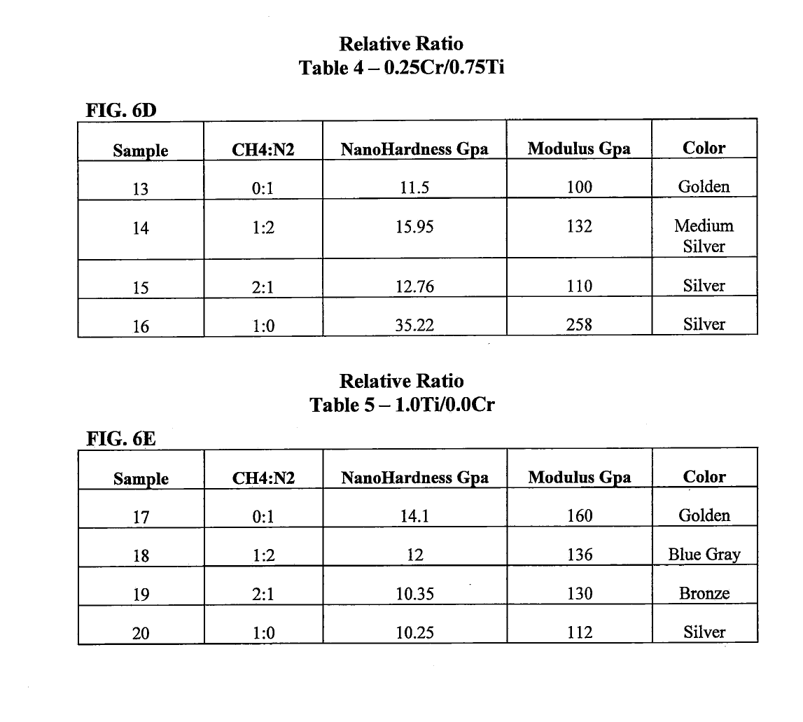

Various embodiments of the present invention provide the scissors 10 with an aesthetically acceptable color or appearance, while indicating to the consumer an often identifiable distinction from known non-coated instruments. Additionally, various embodiments of the present invention are improvements upon known coatings. Samples 5 and 9 (See FIG. 6) represent coatings previously described within U.S. Pat. No. 6,988,318. Various embodiments of the present invention have increased hardness over previously known coatings while maintaining enhanced toughness and expressing increased wear-resistance over non-coated cutting instruments.

The coating 32 increases the ease of use for the scissors 10 by providing the blades 20, 24 with a smooth surface finish, thereby reducing the friction between the blades during use. There is also reduced friction between each blade 20, 24 and the material being cut, thereby providing a smooth cutting action with less cutting effort than blades with out a coating 32. Although there is reduced friction between the blades 20, 24, the coating 32 adheres strongly to the underlying blade substrate surface 34. The coating 32 provides high toughness, low friction and high adhesion strength with the substrate. Various embodiments of the present coating 32 present high toughness based upon the absence of cracking after nanoindentation tests are performed. Alternatively, the coating 32 forms a metallurgical bond with the substrate 20.

Materials cut by the cutting instrument 10 vary widely based upon the desired use of the instrument 10 and the particular coating composition can be altered to be best suited for that particular purpose. For example, the material to be cut can be selected from stationery products including paper, cardboard, bristol board and other fibrous stationary materials. By further example, the material to be cut can be selected from floral-based biomaterials including stems, leaves, twine, and porous wood materials. The coating 32 can be optimized for hardness and resistant to wear in the presence of semi-hard cutting materials and moisture. By further example, the material to be cut can be selected from man-made materials having cured or uncured adhesives.

It is further contemplated that the instrument 10 is not a pair of scissors. The instrument 10 can alternatively be a single blade cutting instrument. By example, the cutting instrument 10 can be selected from a paper trimmer, hobby knife, letter opener, utility knife, pencil sharpener, or rotary paper trimmer. The instrument 10 can be selected from a variety of cutting instruments for which wear resistance, toughness, and hardness improve the operability of the instrument.

Deposition of the coating 32 can be performed through a variety of reactive magnetron sputtering steps. A pulsed direct current (DC) source is utilized. The target size is approximately a 4-inch circular target. The targets are manufactured through combination of titanium and chromium targets in combination of sectors at a 90° angle. The sputtering gas mixture consists of argon, methane and nitrogen. The partial pressure of argon is maintained at approximately 1 millitorr. The partial pressure of nitrogen is maintained at approximately 1 millitorr while the methane gas pressure is maintained at approximately 2 millitorr. The total gas pressure is maintained at approximately 4 millitorr.

Now referring to FIGS. 6A-6E, various coating 32 composition data is represented. FIGS. 6A-6E represent a variance in the relative percentage of methane gas (CH₄) and nitrogen gas (N₂) within the methane/nitrogen mixture. The variances including about 0% methane (CH₄) and about 100% nitrogen (N₂), about 33% methane and about 67% nitrogen, about 66% methane and about 34% nitrogen, and about 100% methane and about 0% nitrogen. In an alternative embodiment of the present invention it is contemplated that the methane percentage can range from about 0% to about 100% and the nitrogen percentage can range from about 100% to about 0%. It is further contemplated that the gas mixture includes a gas other than nitrogen and methane. In an alternative embodiment acetylene gas (C₂H₂) replaces methane as a carbon source. In yet another alternative embodiment ammonia gas (NH₃) replaces nitrogen gas as the nitrogen source.

The sputtering current is maintained at approximately 0.4 amps during the cleaning process, which was completed in approximately 5 minutes. In an alternative embodiment the cleaning process is completed in less than 5 minutes or greater than 5 minutes. The target blades were not coated during the cleaning process due to the use of a shutter, which was withdrawn shortly after the target blades were cleaned. The sputtering current is maintained at a substantially constant level during the coating deposition process. The sputtering current level is maintained at about 0.6 to about 0.7 amps. In an alternative embodiment, the sputtering current is maintained at approximately a constant level, the level can range from about 0.2 amps to about 0.6 amps during the cleaning process. In yet another alternative embodiment, the cleaning process is performed in less than 5 minutes. In yet another alternative embodiment, the deposition current is maintained at a substantially constant level. Alternatively, during the deposition process the level of the current can range from about 0.4 to about 1.0 amps.

During the deposition process the sputtering time is about 20 minutes. The resulting thickness of the coatings is in a range of about 0.4 microns to about 0.5 microns. In an alternative embodiment the coating thickness is in a range of about 0.05 microns to about 1.0 microns. In yet another alternative embodiment, the sputtering deposition time ranges from about 1 minute to about 1 hour. Depending upon the desired target thickness of the coating, the deposition time can be varied to accomplish the target thickness of the coating 32. Alternatively, a thin coating can be applied by limiting the deposition time to less than 20 minutes.

Deposition of the coatings occurs at about 250° C. and the temperature is maintained at substantially the same level. In an alternative embodiment the temperature at which deposition takes place ranges from about 150° C. to about 320° C. In yet another alternative embodiment the temperature at which deposition occurs is greater than about 320° C. In an alternative embodiment the temperature level is varied during the process, with at least two different temperature targets during the deposition process. Alternatively, the temperature at which deposition takes place can be less than 150° C.

In an alternative embodiment, deposition of the coating can be performed by cathode arc plasma (CAP) process with the sputtering gas mixture chosen from the group including argon, nitrogen, methane, acetylene, and ammonia. Two different targets can be used that contain chromium and titanium for the CAP process. It is further contemplated that similar metals can be used. In yet another alternative embodiment, the deposition of the coating 32 can be applied by a process selected from the group including chemical vapor deposition, physical vapor deposition, thermal spraying, or sintering after dip coating.

In an alternative embodiment of the deposition method the partial pressure of methane is maintained at approximately 1 millitorr while the partial pressure of nitrogen is maintained at approximately 2 milltorr. The total gas pressure is also maintained at approximately 4 millitorr.

Hardness of the coating was performed using a nanoindentation procedure. A Hysitron Tribioindenter (Hysitron Inc., Minneapolis, Minn.) was used for nanoindentation testing. A Berkowitz indentor was utilized in conjunction with the Hysitron nanoindentor. A measurement of the nanohardness (GPa) and modulus (GPa) was obtained for each sample tested. The hardness and modulus values are shown in FIGS. 6A-6E.

Each of the various coating compositions identified in FIGS. 6A-6E has a relative color assigned to it. The term “medium” in conjunction with a color identifier describes a darker shade than that color identifier alone. By example, medium silver is darker than silver alone. Bronze is used synonymously with dark golden. Similarly, “blue silver” is a silver modified by the color blue to indicate that the silver color has a bluish tint.

The sample coatings were deposed on polished silicon wafers. The wafers allow for a significantly smooth substrate, which allows for more accurate nanoindentation hardness values. Due to the size of the indenter, a relatively rough surface would cause an unsuitable angle of indentation incidence, which in turn affects the hardness data obtained by nanoindentation. Accurate hardness measurements are obtained through nanoindentation procedures regardless of the substrate so long as the substrate has a substantially smooth surface, as the indenter does not penetrate through the coating 32 into the substrate 20. Nanoindentation allows for data to be obtained for the coating irrespective of the substrate, therefore the use of silicon wafers rather than steel substrates does not affect the testing data obtained. The use of polished silicon wafers as a coating substrate is an accepted procedure for accurate nanoindentation coating tests.

Testing was performed on a variety of coated blade samples. The results of the testing are provided in FIGS. 6A-6E. Testing was performed on 20 coated samples. Each of the samples had a different target coating chemistry. FIGS. 6A-E corresponds to Tables 1-5, each with a different relative ratio of chromium to titanium. By example, Table 2 samples have a relative ratio of 0.75 chromium to 0.25 titanium, and Table 3 samples have a relative ratio of 0.5 chromium to 0.5 titanium. Table 1 samples have no titanium present and Table 5 samples have no chromium present. Within each table there are four samples, which were varied by the ratio of carbon to nitrogen. Methane (CH₄) gas was used as a carbon source, and nitrogen (N₂) gas was used as a source of nitrogen. The relative ratios of carbon to nitrogen included the following ratios: 0:1, 1:3, 2:3, and 1:0. Nanohardness measurement and modulus measurements were obtained for each of the 20 samples, and provided in the respective tables. Alternatively, the relative ratio of carbon to nitrogen can be 1:1. In an alternative embodiment it is contemplated that the relative ratio of carbon to nitrogen can range from about 0:1 to about 1:0. In yet another alternative embodiment it is contemplated that the relative ratio of nitrogen to carbon can range from about 0:1 to about 1:0.

Coating 32 has increased toughness, hardness and wear-resistance over what has been previously known. The coating 32 has a hardness value of about 32.2 gigapascals (GPa) and a modulus of about 259 GPa. The coating 32 comprises an amorphous material including the elements chromium, titanium, carbon, and nitrogen in a relative ratio of about 3 parts chromium to about 1 part titanium. This relative ratio is depicted in FIG. 6B as 0.75 chromium and 0.25 titanium. The coating 32 forms a tight bond with the underlying steel substrate, thereby increasing toughness and reducing flaking. The coating 32 can contain multiple chemical compounds, the compounds being selected from a group including titanium nitride (TiN), chromium nitride (CrN), titanium carbonitride (TiCN), chromium carbonitride (CrCN), titanium carbide (TiC), chromium carbide (CrC), titanium chromium carbonitride (TiCrCN), titanium chromium nitride (TiCrN), and titanium chromium carbide (TiCrC). Alternatively the coating 32 has a hardness in a range of about 30 GPa to about 40 GPa.

In an alternative embodiment, the coating 32 has a hardness in the range of about 10 GPa to about 20 GPa. The coating 32 comprises an amorphous material including the elements titanium and chromium in relative ratio of about equal parts titanium to about equal parts chromium and represented as 0.5 titanium to 0.5 chromium in FIG. 6C. The coating alternatively has a hardness of about 12 GPa. The coating 32 alternatively has a hardness of about 12 GPa. Carbon and nitrogen sources are present in a relative ratio of about 2 parts methane gas to about 1 part nitrogen gas when coating deposition occurs upon the blade 20, 24. Alternatively, the relative ratio is about 1 part methane gas to about 2 parts nitrogen gas. The present embodiment of the coating 32 contains multiple chemical compounds, the compounds being selected from a group including titanium nitride (TiN), chromium nitride (CrN), titanium carbonitride (TiCN), chromium carbonitride (CrCN), titanium carbide (TiC), chromium carbide (CrC), titanium chromium carbonitride (TiCrCN), titanium chromium nitride (TiCrN), and titanium chromium carbide (TiCrC).

In yet another alternative embodiment the coating 32 comprises an amorphous material including the elements chromium, nitrogen and carbon. The coating 32 has a hardness in a range of about 20 GPa to about 25 GPa. The carbon source is methane gas (CH₄) and the nitrogen source is nitrogen gas (N₂). Alternatively the carbon source is acetylene (C₂ and the nitrogen source is ammonia gas (NH₃). The coating 32 contains multiple chemical compounds, the compounds being selected from a group including chromium nitride (CrN), chromium carbonitride (CrCN), and chromium carbide (CrC). Alternative elements can be included as part of the coating composition.

In another alternative embodiment, the coating 32 comprises an amorphous material including the elements chromium, titanium, carbon, and nitrogen. The coating 32 comprises titanium and chromium in relative ratio of about three (3) parts titanium to about one (1) part chromium and represented as 0.75 titanium to 0.25 chromium in FIG. 6D. The coating 32 has a hardness value within a range of about 10 GPa to about 20 GPa. The coating alternatively has a hardness of about 13 GPa. The coating 32 alternatively has a hardness of about 16 GPa. Carbon and nitrogen sources are present in a relative ratio of about 2 parts methane gas to about 1 part nitrogen gas when coating deposition occurs upon the blade 20, 24. Alternatively, the relative ratio is about one (1) part methane gas to about two (2) parts nitrogen gas. The present embodiment of the coating 32 contains multiple chemical compounds, the compounds being selected from a group including titanium nitride (TiN), chromium nitride (CrN), titanium carbonitride (TiCN), chromium carbonitride (CrCN), titanium carbide (TiC), chromium carbide (CrC), titanium chromium carbonitride (TiCrCN), titanium chromium nitride (TiCrN), and titanium chromium carbide (TiCrC).

In yet another alternative embodiment, the coating 32 comprises an amorphous material including the elements titanium, chromium and carbon. The coating 32 comprises titanium and chromium in relative ratio of about equal parts titanium to about equal parts chromium having a hardness of about 26 GPa, and represented as 0.5 titanium to 0.5 chromium in FIG. 6C. Alternatively, the coating 32 comprises titanium and chromium in relative ratio of about three (3) parts titanium to about one (1) part chromium having a hardness of about 35 GPa, and represented as 0.75 titanium to 0.25 chromium in FIG. 6D. The present embodiment of the coating 32 contains multiple chemical compounds, the compounds being selected from a group titanium carbide (TiC), chromium carbide (CrC), and titanium chromium carbide (TiCrC).

In an alternative embodiment, the metal substrate undergoes a polishing step prior to deposition of the coating. The substrate polishing allows for thinner coating thicknesses to be utilized while maintaining complete and uniform deposition. It is contemplated that coating thicknesses can be in a range of about 0.05 microns to about 0.5 microns and the hardness of the coatings provide enhanced qualities at the thinner coating thicknesses.

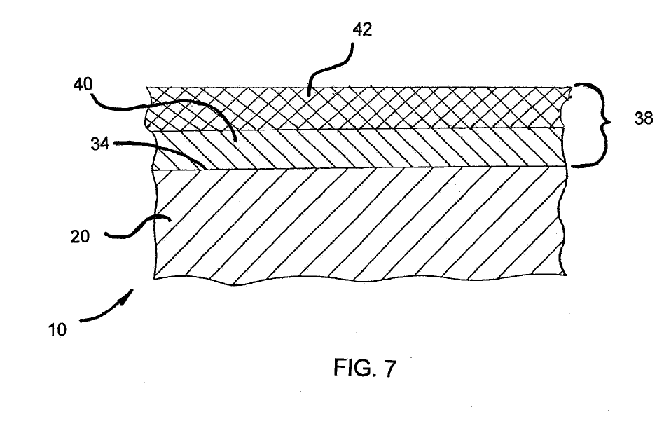

Referring to FIG. 7, a two-layered alternative embodiment coating 38 is shown on a substrate 20. The coating 38 has a first layer 40 and a second layer 42. Each layer 40, 42 comprises an amorphous material including the elements chromium, titanium, carbon, and nitrogen. Layers 40, 42 have varying compositions as the reactive magnetron sputtering process is altered during the deposition process in order to form more than one layer. The present embodiment has a first layer 40 comprising chromium and titanium with a relative ratio of equal parts titanium and chromium. The second layer 42 comprises chromium and titanium in a relative ratio of 3 parts chromium to 1 part titanium. Each layer 40, 42 has a thickness in a range of about 0.02 microns to about 0.5 microns. The layers 40, 42 have a combined thickness in a range of about 0.05 microns to about 1.0 microns. The present embodiment of the coating 38 contains multiple chemical compounds, the compounds being selected from a group including titanium nitride (TiN), chromium nitride (CrN), titanium carbonitride (TiCN), chromium carbonitride (CrCN), titanium carbide (TiC), chromium carbide (CrC), titanium chromium carbonitride (TiCrCN), titanium chromium nitride (TiCrN), and titanium chromium carbide (TiCrC). Alternatively, the layers 40, 42 have a combined thickness in a range of about 0.3 to about 0.5 microns.

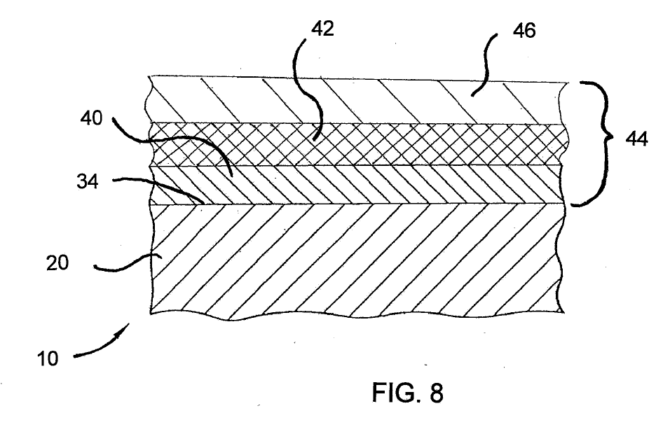

Referring to FIG. 8, a three-layered alternative embodiment coating 44 is shown on substrate 20. The coating 46 has a first layer 40, a second layer 42, and a third layer 46. At least one layer 40, 42, 46 comprises an amorphous material including the elements chromium, titanium, carbon, and nitrogen. Alternatively, the coating 44 has more than 3 layers, the coating 44 having a thickness in a range of about 0.05 microns to about 1.0 microns. Alternatively, the coating 44 has a thickness in a range of about 0.3 to about 0.5 microns.

In an alternative embodiment, the coating of FIG. 8 is the same as the coating of FIG. 7, with the exception that third layer 46 is an outer layer of silicon applied on top of the second layer 42. An outer layer 46 of silicon can provide enhanced lubricity and release qualities for the coating 44. Alternatively, the outer layer 46 can have a variety of materials with the property to achieve lubricity, color, or thermal resistance.

In an alternative embodiment the layers can be altered by removing either the nitrogen source or the carbon source. In the event that the nitrogen source is removed for any one layer 40, 42, 46 there will not be any nitride formation for that particular layer 40, 42, 46. In the event that the carbon source is removed, then there will not be any carbide or carbonitride formation for that particular layer 40, 42, 46. Alternatively, the relative ratios of carbon and nitrogen can be dynamically altered during the deposition process to create a layering effect. The relative rations of carbon and nitrogen can be altered by dynamically controlling the sources, which can be selected from a group including methane gas, nitrogen gas, acetylene gas, and ammonia gas. Each layer 40, 42, 46 can have the same or varied thickness, the thickness being dependent upon the amount of time for each layering deposition process. The instrument 10 remains within the coating chamber throughout the multilayer coating process. Alternatively, the first layer 40 can be applied to the instrument 10 at a different point in time from that of additional layers 42, 46. By example, the cutting instrument can be coated, sharpened and then re-coated. The final coating 46 having a thickness that provides wear-resistance and hardness while maintaining a desired level of blade sharpness.

Although the invention has been described in detail with reference to preferred embodiments, variations and modifications exist within the scope and spirit of the invention as described and defined in the following claims.

1. A cutting instrument comprising:
a cutting blade; and
a coating disposed on the cutting blade, the coating including carbon, titanium, chromium, and nitrogen, wherein the coating further includes a carbonitride.

2. The cutting instrument according to claim 1, wherein the carbonitride is selected from the group consisting of titanium carbonitride, chromium carbonitride and titanium chromium carbonitride.

3. The cutting instrument according to claim 1, wherein the cutting instrument has a pair of complementary cutting blades.

4. A complementary blade cutting instrument comprising:
a first and second cutting blade; and
a coating disposed on the cutting blades, the coating includes an amorphous material including carbon, nitrogen, titanium, and chromium, wherein the coating includes a compound selected from the group consisting of titanium nitride, chromium nitride, titanium carbonitride, chromium carbonitride, titanium carbide, chromium carbide, titanium chromium carbonitride, titanium chromium nitride, and titanium chromium carbide, the coating having a thickness in a range of about 0.05 microns to about 1.0 microns.

5. A method for coating a cutting instrument, the process comprising:
placing the cutting instrument in a position suitable for coating the instrument;
cleaning the cutting instrument; and
depositing a coating on the cutting instrument, the coating comprising titanium carbonitride, chromium carbonitride and titanium chromium carbonitride.
